(19) United States
(12) Patent Application Publication
(10) Pub. No.: US 2011/0307731 A1
(43) Pub. Date: Dec. 15, 2011

(54) METHOD CAPABLE OF PREVENTING ERRONEOUS DATA WRITING AND COMPUTER SYSTEM

(76) Inventor: Wen-Chun Tsao, New Taipei City (TW)

(21) Appl. No.: 13/095,898

(22) Filed: Apr. 28, 2011

(30) Foreign Application Priority Data
Jun. 15, 2010 (TW) 099119464

(51) Int. Cl. G06F 1/28

(52) U.S. Cl. 713/340

(57) ABSTRACT

A method capable of preventing erroneous data writing for a computer system is disclosed. The computer system includes a storage unit for storing digital data, and a processing unit for accessing the digital data stored in the storing unit, the method includes the steps of detecting power supplying status of a supplied power for the computer system, and the processing unit stops accessing the digital data stored in the storage unit after detecting the supply of the supplied power has been suspended.

### BACKGROUND OF THE INVENTION

1. Field of the Invention

The present invention relates to a method capable of preventing erroneous data writing and related computer system, and more particularly, to a method capable of avoiding a voltage ripple occurrence due to power consumption variation in order to prevent erroneous data writing and related computer system.

2. Description of the Prior Art

With the scientific and technological advancement, computer systems are viewed as necessities for ordinary people in their daily lives, and perform traditional functions, such as word processing and program execution, to modern multimedia processing, and computer games, etc. It is therefore an important issue to offer excellent stability and reliability in the computer system. However, when a basic input/output system (BIOS) code or an embedded controller (EC) code is broken or lost, and therefore becomes nonfunctional, the computer will fail to boot. So, the BIOS code or the EC code plays a very important role in the functioning of the computer system during boot-up. If the BIOS code is corrupted or incomplete, the central processor or the EC will not be able to execute a complete code for performing the boot process, and the computer system will fail to perform normal operations.

Please refer to FIG. 1, which is a schematic diagram of a computer system 10 according to the prior art. The computer system 10 includes a central processing unit 102, a southbridge/northbridge chipset 104, an embedded controller (EC) 106, a storage unit 108 and a power supply module 110. The storage unit 108 is utilized for storing related system control codes, such as an EC code, a BIOS code, etc. Moreover, during a boot process, the central processing unit 102 is capable of accessing the BIOS cede stored in the storage unit 108 through the southbridge/northbridge chipset 104 for implementing the related boot process. Similarly, the embedded controller 106 can access the EC code stored in the storage unit 108 for implementing corresponding control operations. The power supply module 110 is utilized for providing power for operating the components of the computer system 10. With increasingly advanced application of the computer system, size and complexity of the system codes are increasing progressively. Further, hardware updates and replacements are more rapid and frequent. Thus, the storage unit 108 is usually a rewritable memory device, such as a serial peripheral interface (SPI) flash memory. However, if an unstable power supply is provided, or an unexpected power problem occurs in the instant that power of the power supply module 110 is turned on or off, part or all of data stored in the storage unit 108 maybe overwritten or erased wrongly, causing permanent damage. Therefore, the data stored in the memory may be corrupted or incomplete, and therefore become nonfunctional. Also, if the impaired data is related to the system code, such as the BIOS code or the EC code, the computer system 10 will fail to perform normal operations.

Please refer to FIG. 2, which is a schematic diagram of related signals of the embedded controller 106 shown in FIG. 1. The power signal P1 is supplied to the embedded controller 106 by the power supply module 110. The clock signal CLK is a clock signal outputted by the embedded controller 106 while accessing the storage unit 108. The period T0 is a normal supply period of the power supply module 110. The period T1 is a period in which the power supply module 110 suspends providing the operating power for the components. In general, when the power supply module 110 suspends the operating power for the components, for example, when a power supply source (such as an A/C adapter or a battery) is removed, the voltage level of the power signal will decrease slowly due to capacitance effect of the components of the computer system 10. For example, during the period T1 (shown in FIG. 2), the power signal P1 decreases slowly (gentle slope). But, the embedded controller 106 may output an unstable clock signal CLK due to the occurrence of unexpected access operation. Therefore, the system codes stored in the storage unit 108 may be overwritten or erased wrongly, and the computer system 10 will fail to perform normal operations.

In detail, please refer to FIG. 3, which is a partial schematic diagram of the power signal P1 shown in FIG. 2 during the period T1. FIG. 3 is an enlarged schematic diagram of the area A1 of FIG. 2. In the macro view (as shown in FIG. 2), the power signal P1 falls slowly and smoothly during the period T1. However, referring to FIG. 3, a ripple phenomenon (i.e. the occurrence of bouncing and vibrating variation of the power signal P1) occurs during the slow falling of the power signal P1. Moreover, after the power supply module 110 stops providing the operating power, the voltage level of the power signal P1 will decrease to a specific voltage level due to discharging operation of capacitance effect. For example, the voltage level of the power signal P1 may fall to a voltage value lower than the operation voltage of the embedded controller 106 when the power supply module 110 stops providing the power. Therefore, the embedded controller 106 will stop all access operations (the storage unit 108 will stop the corresponding access operation as well) and no longer consume any power. After that, because the embedded controller 106 has stopped operating (the storage unit 108 has stopped the corresponding access operation as well), the voltage level of the power signal P1 rises instantaneously due to the reduction of power consumption of the load, and thus, voltage ripples of the power signal P1 occur. In such a situation, the re-risen voltage level of the power signal P1 may exceed the voltage level of the operation voltage of the embedded controller 106, so that the embedded controller 106 mistakenly determines that the power supply module 110 is providing the operating power again. Then, the embedded controller 106 begins to access the storage unit 108 and voltage level of the power signal P1 changes to decrease accordingly. Similarly, the embedded controller 106 stops operation again. In this situation, the electrical power consumption may vary up-and-down with the alternating operations (shut-down and restart) of the components of the computer system 60. Therefore, the voltage level of the supplied power P1 may vary up-and-down accordingly, causing the voltage ripple problem. Of course, the embedded controller 106 may also output an unstable click signal CLK to the storage unit 108 due to the irregular supply power P1.

Please refer to FIGS. 4 and 5. FIG. 4 is a partial schematic diagram of the clock signal CLK shown in FIG. 2 during the period T0. FIG. 5 is a partial schematic diagram of the clock signal CLK shown in FIG. 2 during the period T1. FIGS. 4 and 5 are respectively enlarged schematic diagrams of the areas A2 and A3 of FIG. 2. During the period T0, the power supply module 110 provides the operating power for the embedded controller 106 normally. As shown in FIG. 4, the clock signal CLK is outputted periodically and sequentially. In other words, the clock signal CLK is a stable and regular clock signal in normal operation. After entering the period T1, the power supply module 110 stops providing the operating power. As shown in FIG. 5, the clock signal CLK becomes an irregular clock signal and therefore, an offset effect of the clock signal CLK occurs. When the storage unit 108 receives the clock signal CLK shown in FIG. 5 and related operation commands, read and write cycles of the storage unit 108 may be disordered, and erroneous data writing (or erasing) occurs, causing permanent damage. Therefore, how to prevent the above-mentioned issue should be a concern in progressive system design.

### SUMMARY OF THE INVENTION

It is therefore an objective of the invention to provide a method capable of preventing erroneous data writing and related computer system.

The present invention discloses a method capable of preventing erroneous data writing for a computer system, the computer system comprising a storage unit for storing digital data, and a processing unit for accessing the digital data stored in the storage unit, the method comprising the steps of detecting power supplying status of supplied power for the computer system, and the processing unit stopping accessing the digital data stored in the storage unit after detecting supply of the supplied power has been suspended.

The present invention further discloses a computer system, the computer system comprising a storage unit for storing digital data, a processing unit coupled to the storage unit for accessing the digital data, a power supply module for generating a supplied power for the storage unit and the processing unit, and a detection unit coupled to the storage unit, the processing unit, and the power supply module for detecting power supplying status of the power supply module to generate a detection result, wherein when the detection result indicates the supply of the supplied power has been suspended, the processing unit stops accessing the digital data stored in the storage unit accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer system according to the prior art.

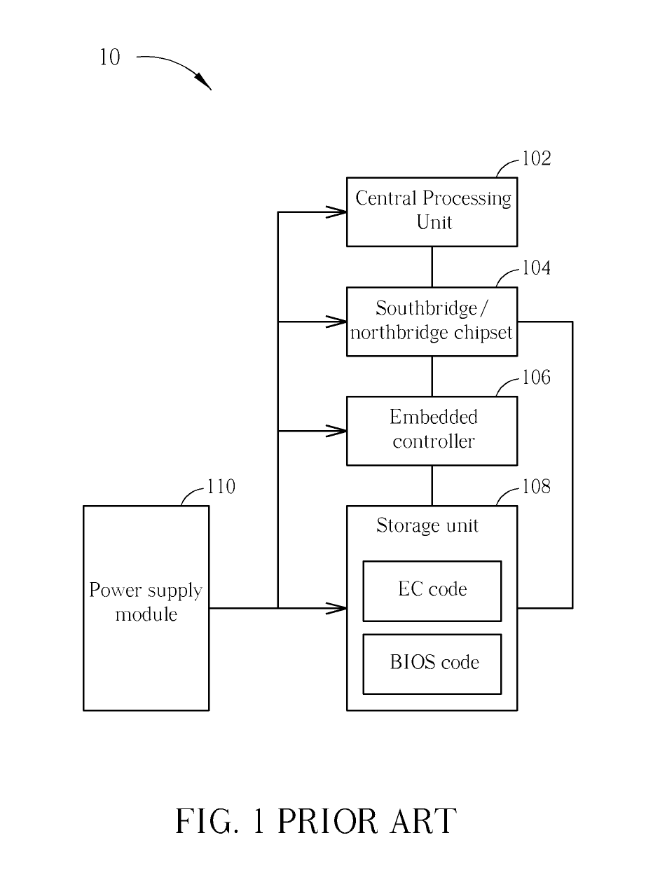

FIG. 2 is a schematic diagram of related signals of the embedded controller shown in FIG. 1.

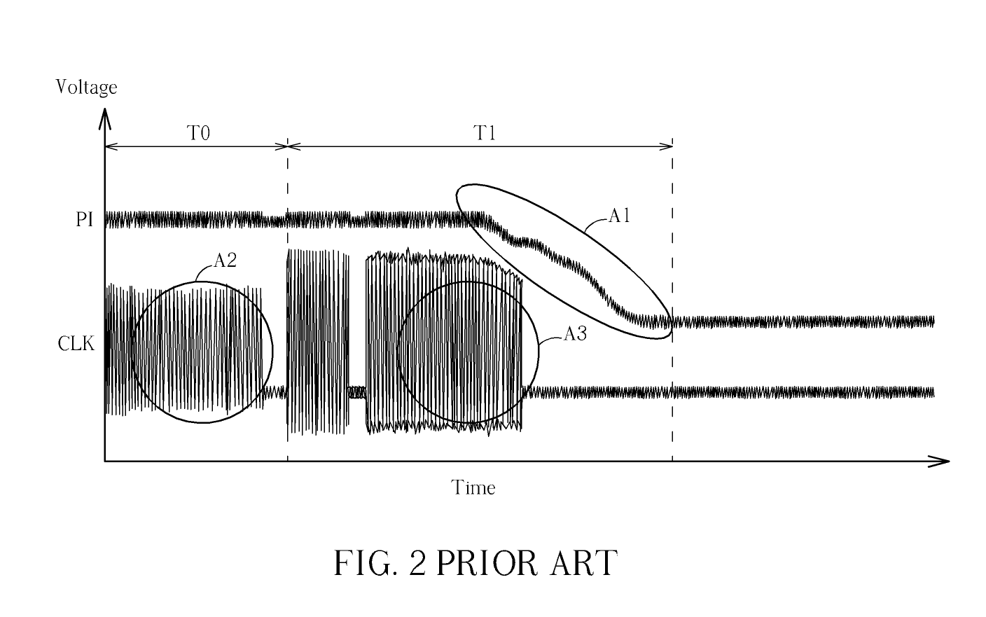

FIG. 3 is a partial schematic diagram of the power signal shown in FIG. 2 during the period T1.

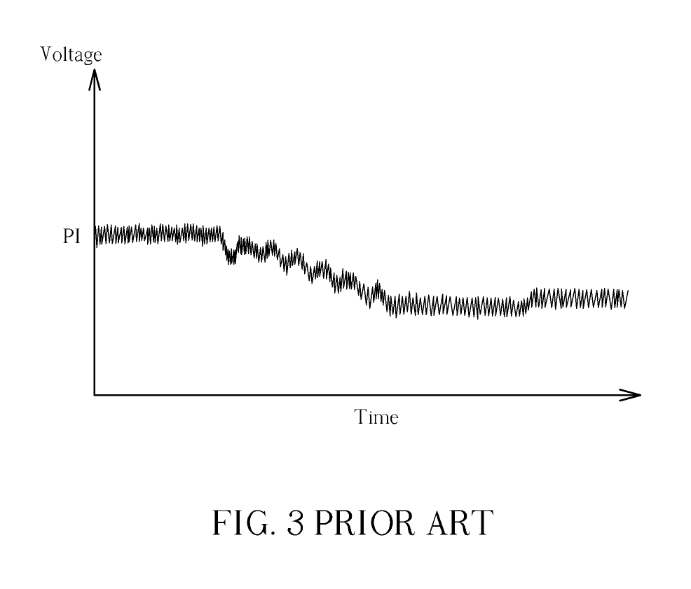

FIG. 4 is a partial schematic diagram of the clock signal shown in FIG. 2 during the period T0.

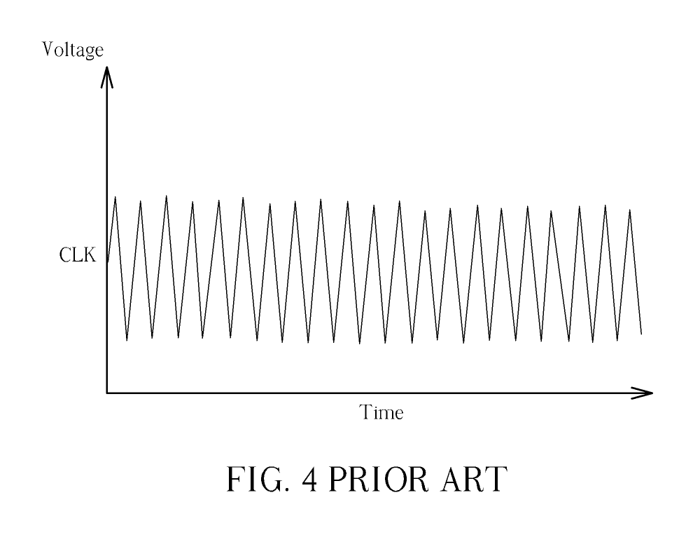

FIG. 5 is a partial schematic diagram of the clock signal shown in FIG. 2 during the period T1.

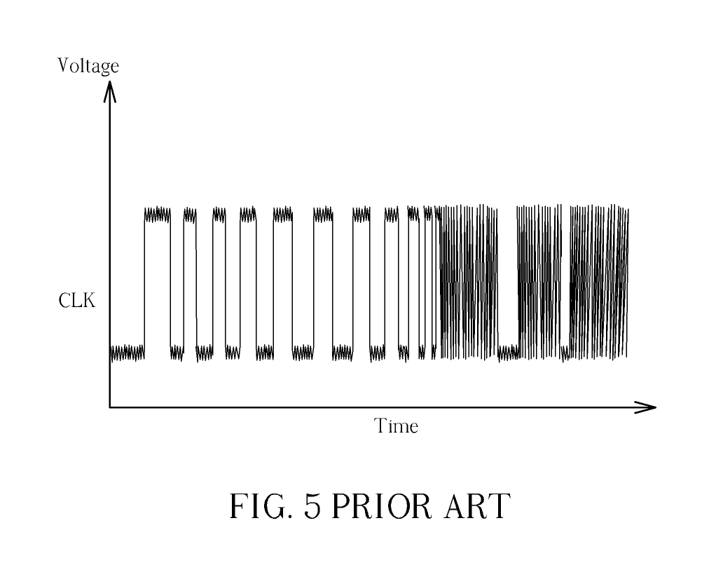

FIG. 6 is a schematic diagram of a computer system according to an embodiment of the invention.

FIG. 7 is a schematic diagram of a procedure according to an embodiment of the invention.

### DETAILED DESCRIPTION

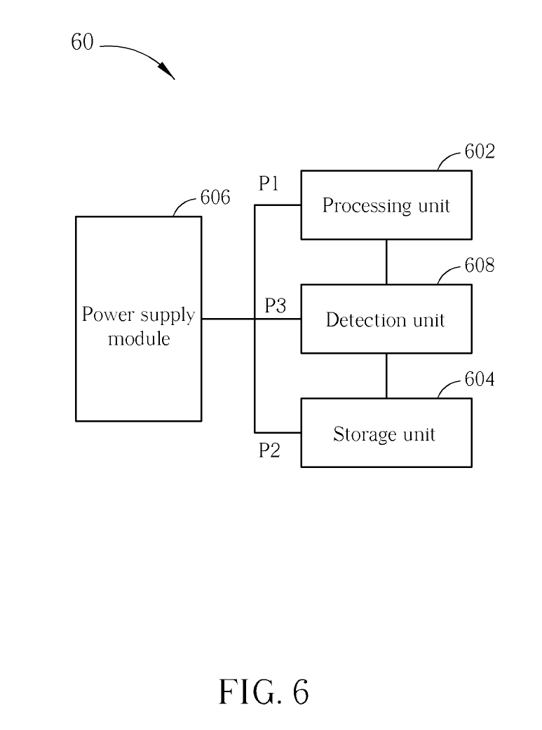

Please refer to FIG. 6, which is a schematic diagram of a computer system 60 according to an embodiment of the invention. The computer system 60 includes a processing unit 602, a storage unit 604, a power supply module 606, and a detection unit 608. The processing unit 602 may be a central processor or an embedded controller (EC), but this should not be a limitation of the invention. The storage unit 604 is coupled to the processing unit 602 for storing digital data. In the embodiment, the storage unit 604 may be a serial peripheral interface (SPI) flash memory or other rewritable storage devices. The digital data includes a BIOS code or an EC code. During a boot process, the processing unit 602 is capable of accessing the BIOS code (or the EC code) stored in the storage unit 604 for implementing the related hardware control or the boot process. The power supply module 606 is coupled to the processing unit 602, the storage unit 604, and the detection unit 608 for generating supplied power P1, P2, and P3 for providing operating power for the components of the computer system 60. The power supply module 606 can be realized by an alternating current (A/C) adapter, a battery, or other apparatus capable of providing the operating power to the components of the computer system 60. The detection unit 608 is coupled to the processing unit 602, the storage unit 604, and the power supply module 606 for detecting power supplying status of the power supply module 606 to generate a detection result accordingly. In other words, the detection unit 608 detects power supplying status of the supplied power P1, P2, and P3 and generates the detection result accordingly. When the detection result indicates that part or all of the supply of the supplied power P1, P2, and P3 has been suspended, the processing unit 602 stops accessing the storage unit 604 according to the detection result. For example, suppose the power supply module 606 utilizes a battery to provide the power. When the battery is removed, the power supply module 606 may discontinue providing electrical power correspondingly. The detection unit 608 may detect the variation of the power supplying status at the same time and further generate the corresponding detection result to show that the supplied power P1 supplied to the processing unit 602 has been terminated, and therefore, the processing unit 602 stops accessing the storage unit 604 correspondingly.

In other words, the voltage ripple may occur while the voltage level of the supplied power provided for the components is slowly decreasing after the supply of the supplied power is suspended. To prevent the above-mentioned undesired voltage ripple occurrence, the invention arranges the processing unit 602 to stop accessing the storage unit 604 after detecting the supply of the supplied power is suspended. In such a situation, the processing unit 602 and the storage unit 604 no longer consume too much operating power for data access operation. As a whole, electrical power consumption of the computer system 60 may not vary up and down, and the ripple phenomenon (i.e. the occurrence of bouncing and vibrating variation of the supplied power) will not take place in the computer system 60, and therefore, erroneous data writing or erasing situations will not occur in the computer system 60.

Furthermore, as stated in the prior art, when voltage level of supplied power decreases to near a specific voltage level (i.e. a minimum voltage level sufficient for providing normal operation of the components of the computer system 60), the components of the computer system 60 may be shut down and restarted repeatedly. In such a situation, the voltage level of the supplied power may vary up and down accordingly, causing the voltage ripple problem. Comparatively, the invention can arrange the processing unit 602 not to access the storage unit 604 to prevent the voltage ripple occurrence when the detection unit 608 detects that the supply of the corresponding supplied power is suspended and the voltage level of the supplied power falls to the minimum voltage level capable of operating the corresponding component. For example, if the processing unit 602 is an embedded controller, the minimum operating voltage to access the storage unit 604 may be 2.7 Volts. For the storage unit 604, the minimum operating voltage may require 3 Volts. Therefore, when the detection result indicates that the supply of the supplied power P1 has been suspended and the voltage level of the supplied power P1 has fallen to 2.7 volts, or the detection result indicates that the supply of the supplied power P2 has been suspended and the voltage level of the supplied power P2 has down to 3 volts, the processing unit 602 is capable of stopping accessing the data stored in the storage unit 604 according to the detection result. In brief, once the supplied power falls to the minimum operation voltage level of the component, the invention can force the corresponding component to break off the related operations requiring higher power consumption, so that the processing unit 602 will not output unstable pulse signals to the storage unit 604.

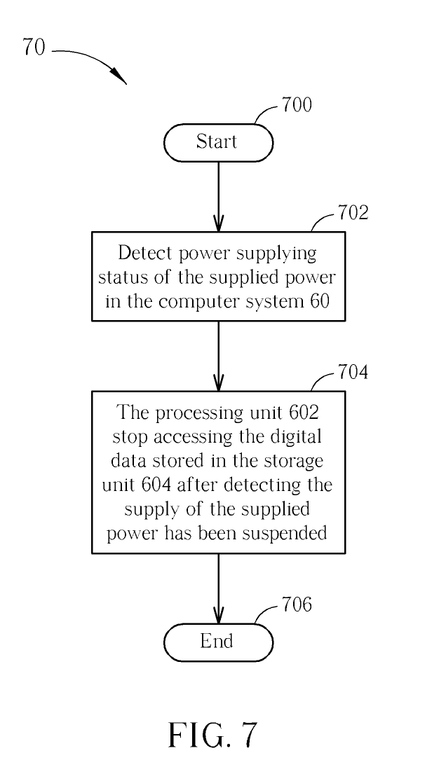

Operations of the computer system 60 may be summarized in a procedure 70 as shown in FIG. 7. The procedure 70 is utilized for preventing the storage unit 604 from suffering the erroneous writing (or erasing) occurrences. The procedure 70 includes the following steps:

Step 700: Start.

Step 702: Detect power supplying status of the supplied power in the computer system 60.

Step 704: The processing unit 602 stops accessing the digital data stored in the storage unit 604 after detecting the supply of the supplied power has been suspended.

Step 706: End.

According to the procedure 70, in Step 702, the detection unit 608 may detect the power supplying status of the power supply module 606 providing the operating power for the components of the computer system 60 so as to generate a detection result, this means that the detection unit 608 can detect the power supplying status of the supplied power P1, P2, and P3 to generate the detection result accordingly. After that, in Step 704, when the detection result indicates the supply of the supplied power is suspended, i.e. part or all of the supply of the supplied power P1, P2, and P3 has been suspended, the processing unit 602 can stop accessing the data stored in the storage unit 604 accordingly. Moreover, since the processing unit 602 accesses the data stored in the storage unit 604, the processing unit 602 may consume much electrical power during the data reading period. Therefore, when the supply of the supplied power is suspended, the invention prohibits the processing unit 602 from accessing the storage unit 604 so as to avoid great variation of electrical power consumption and the occurrence of unstable voltage ripple effect of the power supply.

Furthermore, in Step 704, when the detection result indicates that the supply of the supplied power has been suspended or when the voltage level of the supplied power P1 has fallen to a specific voltage level, the processing unit 602 is preferably capable of fetching and executing a loop command or a stop command from the storage unit 604 or other storage devices. For example, the loop command can be a “while ( )” loop command, the stop command can be a “JMP$” stop command, and these should not be a limitation of the invention. Moreover, the loop command maybe designed into an infinite loop command, that is, the loop command may be programmed to a command executing a specific program code repeatedly for looping endlessly. So, if the processing unit 602 executes the loop command, the processing unit 602 will recursively execute the loop command and no longer access the data stored in the storage unit 604. In addition, after the processing unit 602 executes the stop command, the processing unit 602 may stop performing related operations accordingly, as well as accessing the storage unit 604. On the whole, the processing unit 602 is able to stop accessing the storage unit 604 after executing the loop command or the stop command so that the processing unit 602 does not consume too much electrical power. Meanwhile, at the most, the processing unit 602 only executes the loop command (or the stop command) being fetched and stored in the register repeatedly. In such a situation, the power consumption of the processing unit 602 will be kept at a fixed value (which is lower than the power consumption value) during data access processes. In other words, the processing unit 602 can achieve the purpose of stopping accessing the storage unit 604 through executing a loop command or a stop command.

In summary, the voltage ripple may occur while the voltage level of the supplied power provided for the components slowly decreases after the supply of the supplied power is suspended in the prior art. To prevent the above-mentioned undesired voltage ripple occurrence, the invention can force the components to stop related access operations requiring large power consumption to prevent the drastic variation of the electrical power consumption for the computer system. The voltage ripple phenomenon will not take place in the computer system, and therefore, erroneous data writing and erasing situations will not occur in the computer system 60.

Those skilled in the art will readily observe that numerous modifications and alterations of the device and method may be made while retaining the teachings of the invention.

What is claimed is:

1. A method capable of preventing erroneous data writing for a computer system, the computer system comprising a storage unit for storing digital data, and a processing unit for accessing the digital data stored in the storage unit, the method comprising the steps of:
detecting power supplying status of supplied power for the computer system; and
the processing unit stopping accessing the digital data stored in the storage unit after detecting supply of the supplied power has been suspended.

2. The method of claim 1, wherein the step of detecting power supplying status of the supplied power for the computer system comprises detecting the power supplying status of a first power supplied for the processing unit and a second power supplied for the storage unit.

3. The method of claim 2, wherein the step of the processing unit stopping accessing the digital data stored in the storage unit after detecting the supply of the supplied power has been suspended comprises the processing unit stopping accessing the digital data stored in the storage unit after detecting the supply of the first power or the second power has been suspended.

4. The method of claim 2, wherein the step of the processing unit stopping accessing the digital data stored in the storage unit after detecting the supply of the supplied power has been suspended comprises the processing unit stopping accessing the digital data stored in the storage unit when the supply of the first power has been suspended and voltage level of the first power falls to a first voltage level.

5. The method of claim 2, wherein the step of the processing unit stopping accessing the digital data stored in the storage unit after detecting the supply of the supplied power has been suspended comprises the processing unit stopping accessing the digital data stored in the storage unit when the supply of the second power has been suspended and voltage level of the second power falls to a second voltage level.

6. The method of claim 1, wherein the step of the processing unit stopping accessing the digital data stored in the storage unit after detecting the supply of the supplied power has been suspended comprises the processing unit recursively executing a loop command or a stop command for stopping accessing the digital data stored in the storage unit after detecting the supply of the supplied power has been suspended.

7. The method of claim 1, wherein the processing unit is a central processor or an embedded controller.

8. The method of claim 1, wherein the storage unit is a serial peripheral interface flash memory.

9. The method of claim 1, wherein the supplied power is provided by an alternating current (A/C) adapter or a battery.

10. The method of claim 1, wherein the digital data comprises a basic input/output system code or an embedded controller code.

11. A computer system, comprising:
a storage unit for storing digital data;
a processing unit coupled to the storage unit for accessing the digital data;
a power supply module for generating a supplied power for the storage unit and the processing unit; and
a detection unit coupled to the storage unit, the processing unit, and the power supply module for detecting power supplying status of the power supply module to generate a detection result;
wherein when the detection result indicates the supply of the supplied power has been suspended, the processing unit stops accessing the digital data stored in the storage unit accordingly.

12. The computer system of claim 11, wherein the power supply module comprises a first power supplied for the processing unit and a second power supplied for the storage unit.

13. The computer system of claim 12, wherein when the detection result indicates the supply of the first power or the second power has been suspended, the processing unit stops accessing the digital data stored in the storage unit.

14. The computer system of claim 12, wherein when the detection result indicates the supply of the first power has been suspended and voltage level of the first power falls to a first voltage level, the processing unit stops accessing the digital data stored in the storage unit.

15. The computer system of claim 12, wherein when the detection result indicates the supply of the second power has been suspended and voltage level of the second power falls to a second voltage level, the processing unit stops accessing the digital data stored in the storage unit.

16. The computer system of claim 11, wherein when the detection result indicates the power supply of the power supply module has been suspended, the processing unit recursively executes a loop command or a stop command for stopping accessing the digital data stored in the storage unit after detecting the supply of the supplied power has been suspended.

17. The computer system of claim 11, wherein the processing unit is a central processor or an embedded controller.

18. The computer system of claim 11, wherein the storage unit is a serial peripheral interface flash memory.

19. The computer system of claim 11, wherein the supplied power is provided by an alternating current (A/C) adapter or a battery.

20. The computer system of claim 11, wherein the digital data comprises a basic input/output system code or an embedded controller code.
